(19) United States
(12) Patent Application Publication
(10) Pub. No.: US 2019/0314865 A1
(43) Pub. Date: Oct. 17, 2019

(54) CLEANING APPARATUS FOR SENSOR

(71) Applicant: Ford Global Technologies, LLC, Dearborn, MI (US)

(72) Inventors: Manan Sevak, Southfield, MI (US); David Doellstedt, Dearborn, MI (US); Venkatesh Krishnan, Canton, MI (US)

(73) Assignee: Ford Global Technologies, LLC, Dearborn, MI (US)

(21) Appl. No.: 15/954,636

(22) Filed: Apr. 17, 2018

(51) Int. Cl. B08B 3/02

(52) U.S. Cl. CPC B08B 3/02

(57) ABSTRACT

A cleaning apparatus includes a ring-shaped tube including first and second chambers from an inlet end to a terminal end, a compressed gas source connected to the first chamber, and a liquid reservoir connected to the second chamber. The tube includes a slot outwardly directed from the first chamber extending substantially from the inlet end to the terminal end, and a plurality of nozzles outwardly directed from the second chamber.

### BACKGROUND

Autonomous vehicles typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices. When sensor lenses, covers, and the like become dirty, smudged, etc., sensor operation can be impaired or precluded.

### BRIEF DESCRIPTION OF THE DRAWINGS

FIG. 1 is a side view of an example vehicle with a sensor assembly.

FIG. 2 is a perspective view of the sensor assembly on a roof of the vehicle.

FIG. 3 is a diagram of an example cleaning apparatus for the sensor assembly.

FIG. 4 is a perspective view of an example tube of the cleaning apparatus and a sensor.

FIG. 5 is a cutaway view of a portion of the tube.

FIG. 6 is a cutaway view of a portion of another example tube.

FIG. 7 is a top view of the cleaning apparatus.

### DETAILED DESCRIPTION

A cleaning apparatus includes a tube, a compressed gas source, and a liquid reservoir. The tube includes first and second chambers from an inlet end to a terminal end. The tube includes a slot outwardly directed from the first chamber extending substantially from the inlet end to the terminal end, and a plurality of nozzles outwardly directed from the second chamber. The compressed gas source is connected to the first chamber. The liquid reservoir is connected to the second chamber.

The tube may be ring-shaped. The slot and the nozzles may be aimed at an axis defined by a line that is orthogonal to, and passes through a center of, a circle defining the tube.

The cleaning apparatus may further include a cylindrical sensor, and the slot and the nozzles may be aimed at the sensor.

The slot may be disposed radially outside the nozzles.

The slot may extend along the tube with a constant width.

A cross-sectional area of the first chamber may be larger than a cross-sectional area of the second chamber.

The nozzles may be substantially evenly spaced along the tube.

The cleaning apparatus may further include a windshield, and the liquid reservoir may be arranged to supply liquid to the windshield.

The compressed gas source may be connected to the first chamber via a first inlet at the inlet end of the tube.

The liquid reservoir may be connected to the second chamber via a second inlet at the inlet end of the tube.

The terminal end may be closed.

A method includes providing a tube including first and second chambers from an inlet end to a terminal end, supplying compressed gas to the first chamber, and supplying liquid to the second chamber. The tube includes a slot outwardly directed from the first chamber extending substantially from the inlet end to the terminal end, and a plurality of nozzles outwardly directed from the second chamber.

The tube may be ring-shaped. The slot and the nozzles may be aimed at an axis defined by a line that is orthogonal to, and passes through a center of, a circle defining the tube.

The slot and the nozzles may be aimed at a cylindrical sensor.

The slot may be disposed radially outside the nozzles.

The slot may extend along the tube with a constant width.

A cross-sectional area of the first chamber may be larger than a cross-sectional area of the second chamber.

The method may further include supplying liquid to a windshield from a same source as for supplying liquid to the second chamber.

With reference to the Figures, a cleaning apparatus 30 includes a ring-shaped tube 32 including first and second chambers 34, 36 from an inlet end 38 to a terminal end 40, a compressed gas source 42 connected to the first chamber 34, and a liquid reservoir 44 connected to the second chamber 36. The tube 32 includes a slot 46 outwardly directed from the first chamber 34 extending substantially from the inlet end 38 to the terminal end 40, and a plurality of nozzles 48 outwardly directed from the second chamber 36.

The cleaning apparatus 30 is efficient and economical. Integrating the delivery of compressed gas and liquid into the single tube 32 can reduce the number of components, reduce weight, and reduce stack-up, i.e., height or vertical space occupied by the cleaning apparatus 30. Simplifying and reducing the number of components can reduce the cost of the cleaning apparatus 30. The tube 32 has a constant cross-section (other than the nozzles 48) from the inlet end 38 to the terminal end 40, allowing the tube 32 to be manufactured with extruded plastic. The tube 32 can thus provide easier and less costly manufacturing.

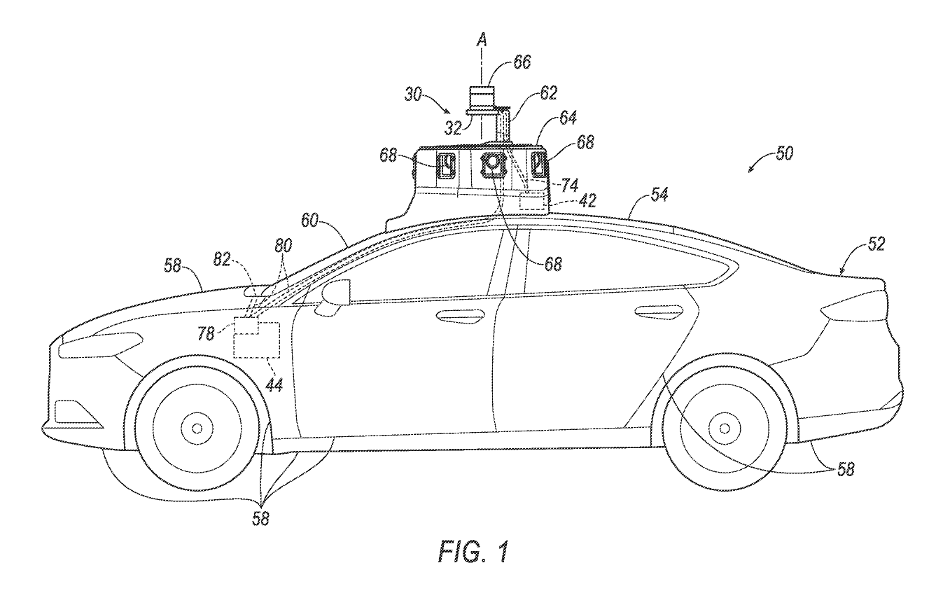

With reference to FIG. 1, a vehicle 50 may be an autonomous vehicle. A computer can be configured to operate the vehicle 50 independently of the intervention of a human driver, completely or to a lesser degree. The computer may be programmed to operate the propulsion, brake system, steering, and/or other vehicle systems. For the purposes of this disclosure, autonomous operation means the computer controls the propulsion, brake system, and steering; semi-autonomous operation means the computer controls one or two of the propulsion, brake system, and steering and a human driver controls the remainder; and nonautonomous operation means the human driver controls the propulsion, brake system, and steering.

The vehicle 50 includes a body 52. The vehicle 50 may be of a unibody construction, in which a frame and a body 52 of the vehicle 50 are a single component. The vehicle 50 may, alternatively, be of a body-on-frame construction, in which the frame supports a body 52 that is a separate component from the frame. The frame and body 52 may be formed of any suitable material, for example, steel, aluminum, etc.

The body 52 includes body panels 54, 56, 58 partially defining an exterior of the vehicle 50. The body panels 54, 56, 58 may present a class-A surface, e.g., a finished surface exposed to view by a customer and free of unaesthetic blemishes and defects. The body panels 54, 56, 58 include, e.g., a roof 54, a hood 56, etc.

A windshield 60 may be supported by the body 52. The windshield 60 may be positioned so that occupants of the vehicle 50 view through the windshield 60 in a vehicle-forward direction from a passenger cabin. The windshield 60 may be positioned between the hood 56 and the roof 54. The windshield 60 may be formed of any suitably durable transparent material, including glass such as laminated, tempered glass or plastic such as Plexiglas® or polycarbonate.

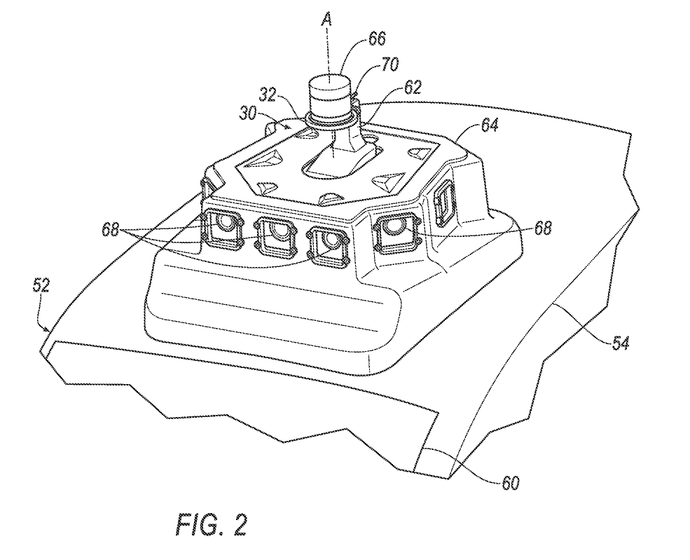

With reference to FIG. 2, a mounting bracket 62 may be connectable to the vehicle 50. For example, the mounting bracket 62 may be attached to a housing 64 that supports and houses a plurality of sensors 66, 68. The mounting bracket 62 may be elongated vertically relative to the vehicle 50. The mounting bracket 62 may be a rigid structure that supports the cleaning apparatus 30 and one or more of the sensors 66, 68. For example, a first sensor 66 may be supported by the mounting bracket 62, and second sensors 68 may be housed by the housing 64. The mounting bracket 62 may support the first sensor 66 and the cleaning apparatus 30 above the housing 64 and above the roof 54. The mounting bracket 62 may be integral with, i.e., cast, molded, etc. as a single piece with, the housing 64, or the mounting bracket 62 may be a separate piece that is fixedly attached to the housing 64, e.g., via conventional attachment means, such as adhesives, fasteners, snaps, etc. The housing 64 may be fixedly attached to one of the body panels 54, 56, 58, e.g., to the roof 54, e.g., via conventional attachment means, such as adhesives, fasteners, snaps, etc.

The sensors 66, 68 may provide data about operation of the vehicle 50, for example, wheel speed, wheel orientation, and engine and transmission data (e.g., temperature, fuel consumption, etc.). The sensors 66, 68 may detect the location and/or orientation of the vehicle 50. For example, the sensors 66, 68 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 66, 68 may detect the external world, e.g., objects and/or characteristics of surroundings of the vehicle 50, such as other vehicles, road lane markings, traffic lights and/or signs, pedestrians, etc. For example, the sensors 66, 68 may include radar sensors, scanning laser range finders, light detection and ranging (LIDAR) devices, and image processing sensors such as cameras. A LIDAR device detects distances to objects by emitting laser pulses at a particular wavelength and measuring the time of flight for the pulse to travel to the object and back. In particular, the first sensor 66 may be a LIDAR device, and the second sensors 68 may be cameras. Alternatively or additionally, the mounting bracket 62 may support multiple first sensors 66, e.g., multiple LIDAR devices.

The first sensor 66 may have a cylindrical shape oriented vertically, i.e., an axis A of the cylindrical shape is substantially vertical. The first sensor 66 may define the axis A. The first sensor 66 may include a sensor window 70, which may extend 360° about the axis A.

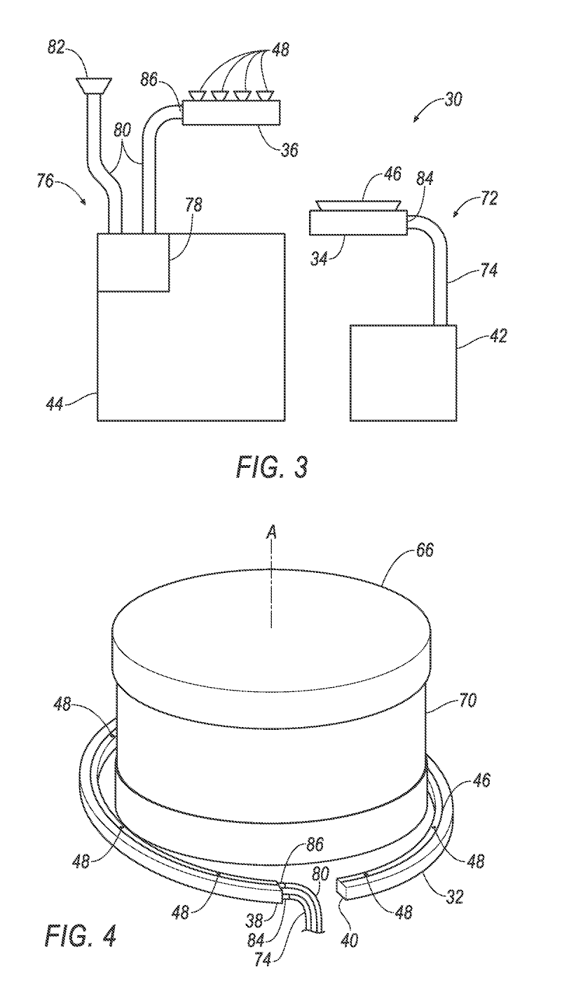

With reference to FIG. 3, a gas system 72 includes the compressed gas source 42, a gas supply line 74, the first chamber 34, and the slot 46. The compressed gas source 42 and the first chamber 34 are fluidly connected to each other (i.e., fluid can flow from one to the other) in sequence through the gas supply line 74.

The compressed gas source 42 provides a supply of gas at higher-than-atmospheric pressure. For example, the compressed gas source 42 may be a compressor, i.e., may increase the pressure of a gas by reducing a volume of the gas or by forcing additional gas into a constant volume. The compressed gas source 42 may be any suitable type of compressor, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; or any other suitable type. For another example, the compressed gas source 42 may be tank containing already-pressurized gas. The compressed gas source 42 may be disposed, e.g., in the housing 64. The compressed gas may be, e.g., air.

The gas supply line 74 extends from the compressed gas source 42 to the first chamber 34. The gas supply line 74 may be, e.g., a flexible tube.

A liquid system 76 of the vehicle 50 includes the liquid reservoir 44, a pump 78, liquid supply lines 80, a windshield sprayer 82, the second chamber 36, and the nozzles 48. The liquid reservoir 44, the pump 78, the windshield sprayer 82, the second chamber 36, and the nozzles 48 are fluidly connected to each other (i.e., fluid can flow from one to the other). The liquid system 76 is arranged to supply washer fluid stored in the liquid reservoir 44 to the windshield sprayer 82 and to the nozzles 48. “Washer fluid” refers to any liquid stored in the reservoir for cleaning. The washer fluid may include solvents, detergents, diluents such as water, etc.

The liquid reservoir 44 may be a tank fillable with liquid, e.g., washer fluid for window cleaning. The liquid reservoir 44 may be disposed in a front of the vehicle 50, specifically, in an engine compartment forward of a passenger cabin. The liquid reservoir 44 may store the washer fluid both for supplying the second chamber 36 and the windshield 60, as well as possibly other destinations. Alternatively, the liquid reservoir 44 may exclusively supply washer fluid to the second chamber 36, and a separate reservoir may supply washer fluid to the windshield 60.

The pump 78 may force the washer fluid through the liquid supply lines 80 to the windshield sprayer 82 and/or the nozzles 48 with sufficient pressure that the washer fluid sprays from the windshield sprayer 82 and/or the nozzles 48. The pump 78 is fluidly connected to the liquid reservoir 44. The pump 78 may be attached to or disposed in the reservoir.

The liquid supply lines 80 extend from the pump 78 to the windshield sprayer 82 and to the nozzles 48. The liquid supply lines 80 may be, e.g., flexible tubes.

The windshield sprayer 82 may be, e.g., a nozzle or outlet suitable for delivering washer fluid to all or a large proportion of the windshield 60.

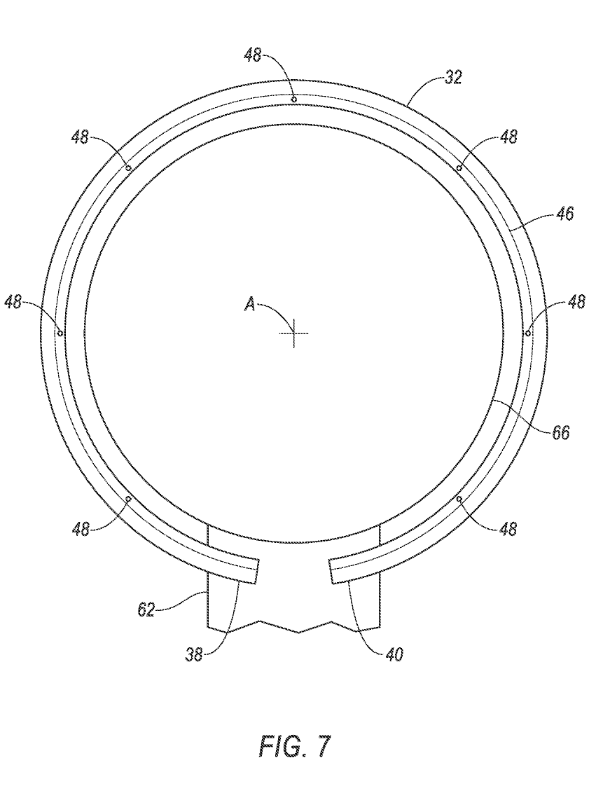

With reference to FIG. 4, the tube 32 is elongated from the inlet end 38 to the terminal end 40. The tube 32 may have a shape matching a shape of the first sensor 66, such as rectangular, triangular, etc. For a first sensor 66 that is cylindrical, the tube 32 may be ring-shaped. The tube 32 may be elongated along a circumference of a circle, and the tube 32 may be elongated along most of the circumference, e.g., more than 330° along the circumference. The tube 32 may be concentrically centered about the first sensor 66, as shown in FIG. 7; in other words, the axis A defined by the sensor may be orthogonal to and pass through a center of the circle defining the tube 32. The tube 32 thus also defines the axis A. The tube 32 may be positioned below the first sensor 66 or below the sensor window 70 of the first sensor 66.

The inlet end 38 includes a first inlet 84 and a second inlet 86. The first inlet 84 may connect the gas supply line 74, and thus the compressed gas source 42, to the first chamber 34. The first inlet 84 may be sized to receive the gas supply line 74. The second inlet 86 connects one of the liquid supply lines 80, and thus the liquid reservoir 44, to the second chamber 36. The second inlet 86 may be sized to receive the liquid supply lines 80.

The terminal end 40 may be closed; in other words, the terminal end 40 may include no inlets or outlets. The first and second chambers 34, 36 may have no outlets other than the slot 46 and the nozzles 48.

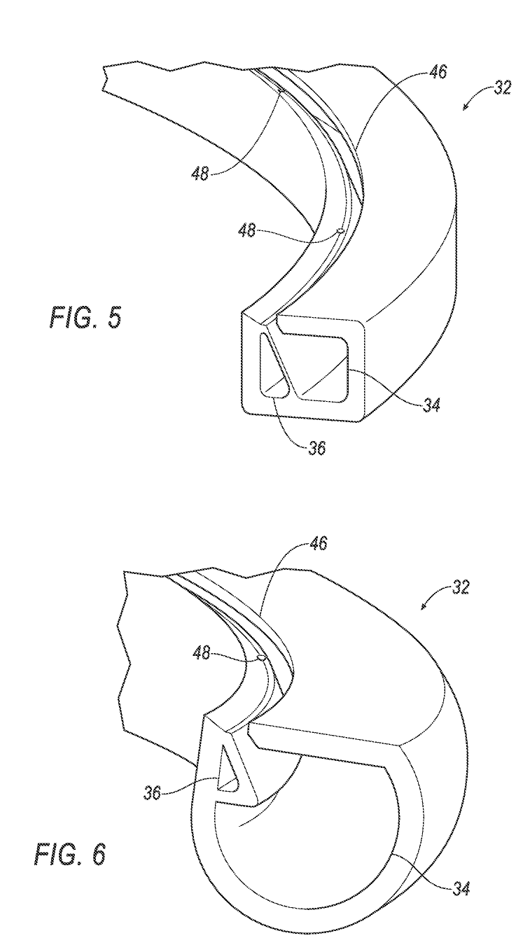

With reference to FIGS. 5 and 6, the first and second chambers 34, 36 may have a constant cross-section from the inlet end 38 to the terminal end 40. The cross-sectional area of the first chamber 34 may be larger than the cross-sectional area of the second chamber 36. Alternatively, the cross-sectional areas of the first chamber 34 and/or the second chamber 36 may vary from the inlet end 38 to the terminal end 40. For example, the cross-sectional areas of the first chamber 34 and/or the second chamber 38 may increase or decrease, e.g., monotonically, from the inlet end 38 to the terminal end 40. For another example, the cross-sectional area of the first chamber 34 may be varied from the inlet end 38 to the terminal end 40 such that a flow rate or pressure of the washer fluid exiting the slot 46 is substantially constant from the inlet end 38 to the terminal end 40. For another example, the cross-sectional area of the second chamber 36 may be varied from the inlet end 38 to the terminal end 40 such that a flow rate or pressure of the gas exiting each nozzle 48 is substantially the same. At least some of the first chamber 34 is radially outside the second chamber 36 relative to the axis A, i.e., farther from the axis A.

The slot 46 is outwardly directed from the first chamber 34 to an ambient environment. For the purposes of this disclosure, “outwardly directed from a chamber” means extending from a chamber to outside the chamber. From the first chamber 34, the slot 46 may be directed upward and radially inward, i.e., toward the axis A. The slot 46 may be aimed at the first sensor 66, e.g., at the sensor window 70. The slot 46 may extend substantially from the inlet end 38 to the terminal end 40. The slot 46 may have a constant width along the tube 32. Alternatively, the slot 46 may increase or decrease, e.g., monotonically, from the inlet end 38 to the terminal end 40. The slot 46 may be disposed radially outside the nozzles 48.

With reference to FIG. 7, the nozzles 48 are outwardly directed from the second chamber 36 to an ambient environment. From the second chamber 36, the nozzles 48 may be directed upward and radially inward, i.e., toward the axis A. The nozzles 48 may be aimed at the first sensor 66, e.g., at the sensor window 70. The nozzles 48 may be substantially evenly spaced along the tube 32, i.e., along a circumference of a circle defined by the tube 32.

In operation, the vehicle 50 is provided with the tube 32 for cleaning the first sensor 66. The gas system 72 supplies compressed gas to the first chamber 34, which exits from the slot 46 to blow debris off the sensor window 70 as well as possibly block debris from landing on the sensor window 70. The compressed gas may be supplied continuously while the vehicle 50 is in operation or on demand. The liquid system 76 supplies liquid such as washer fluid to the second chamber 36, which exits from the nozzles 48 to wash the sensor window 70. The liquid may be supplied on demand. The compressed gas may also be supplied for drying the sensor window 70 after liquid has been applied. The liquid system 76 may supply liquid to the windshield 60 via the windshield sprayer 82 from the same source, e.g., the liquid reservoir 44, as for supplying liquid to the second chamber 36.

The disclosure has been described in an illustrative manner, and it is to be understood that the terminology which has been used is intended to be in the nature of words of description rather than of limitation. “Substantially” as used herein means that a dimension, time duration, shape, or other adjective may vary slightly from what is described due to physical imperfections, power interruptions, variations in machining or other manufacturing, etc. Many modifications and variations of the present disclosure are possible in light of the above teachings, and the disclosure may be practiced otherwise than as specifically described.

What is claimed is:

1. A cleaning apparatus comprising:
a tube including first and second chambers from an inlet end to a terminal end and including a slot outwardly directed from the first chamber extending substantially from the inlet end to the terminal end, and a plurality of nozzles outwardly directed from the second chamber;
a compressed gas source connected to the first chamber; and
a liquid reservoir connected to the second chamber.

2. The cleaning apparatus of claim 1, wherein the tube is ring-shaped.

3. The cleaning apparatus of claim 2, wherein the slot and the nozzles are aimed at an axis defined by a line that is orthogonal to, and passes through a center of, a circle defining the tube.

4. The cleaning apparatus of claim 2, further comprising a cylindrical sensor, wherein the slot and the nozzles are aimed at the sensor.

5. The cleaning apparatus of claim 2, wherein the slot is disposed radially outside the nozzles.

6. The cleaning apparatus of claim 1, wherein the slot extends along the tube with a constant width.

7. The cleaning apparatus of claim 1, wherein a cross-sectional area of the first chamber is larger than a cross-sectional area of the second chamber.

8. The cleaning apparatus of claim 1, wherein the nozzles are substantially evenly spaced along the tube.

9. The cleaning apparatus of claim 1, further comprising a windshield, wherein the liquid reservoir is arranged to supply liquid to the windshield.

10. The cleaning apparatus of claim 1, wherein the compressed gas source is connected to the first chamber via a first inlet at the inlet end of the tube.

11. The cleaning apparatus of claim 1, wherein the liquid reservoir is connected to the second chamber via a second inlet at the inlet end of the tube.

12. The cleaning apparatus of claim 1, wherein the terminal end is closed.

13. A method comprising:
providing a tube including first and second chambers from an inlet end to a terminal end, a slot outwardly directed from the first chamber extending substantially from the inlet end to the terminal end, and a plurality of nozzles outwardly directed from the second chamber;
supplying compressed gas to the first chamber; and
supplying liquid to the second chamber.

14. The method of claim 13, wherein the tube is ring-shaped.

15. The method of claim 14, wherein the slot and the nozzles are aimed at an axis defined by a line that is orthogonal to, and passes through a center of, a circle defining the tube.

16. The method of claim 14, wherein the slot and the nozzles are aimed at a cylindrical sensor.

17. The method of claim 14, wherein the slot is disposed radially outside the nozzles.

18. The method of claim 13, wherein the slot extends along the tube with a constant width.

19. The method of claim 13, wherein a cross-sectional area of the first chamber is larger than a cross-sectional area of the second chamber.

20. The method of claim 13, further comprising supplying liquid to a windshield from a same source as for supplying liquid to the second chamber.
